(19) United States
(12) Patent Application Publication
(10) Pub. No.: US 2012/0052465 A1
(43) Pub. Date: Mar. 1, 2012

(54) DENTAL MODEL AND METHOD FOR ITS MANUFACTURING

(75) Inventors: Holger Von Both, Singen (DE); Rupert Flögel, Göbrichen/Neulingen (DE)

(73) Assignee: WIELAND DENTAL + TECHNIK GMBH & CO. KG, Pforzheim (DE)

(21) Appl. No.: 13/254,924

(22) PCT Filed: Mar. 4, 2010
(86) PCT No.: PCT/EP10/01335

§ 371 Date: Nov. 17, 2011

(30) Foreign Application Priority Data
Mar. 6, 2009 (DE) 10 2009 013 153.1

(51) Int. Cl. A61C 13/36; B23Q 11/00

(52) U.S. Cl. 433/213; 409/131

(57) ABSTRACT

A dental model includes a base unit having a shape of a section of a jaw and gums of a patient, and at least one removable tooth component which is inserted along a z-axis into a dedicated tooth component recess of the base unit, wherein the removable tooth component includes a tooth section having the shape of a tooth or a tooth stump, the tooth component recess has a substantially cylindrical main recess, the removable tooth component has a plug-in section that is substantially cylindrical and is inserted in the main recess of the tooth component recess, an orientation projection is disposed on one surface of the tooth component away from the tooth section, extending along the z-axis, the tooth component recess that accommodates the orientation projection has an orientation recess adjoining the main recess to accommodate the orientation projection, and the orientation projection and the orientation recesses are designed and/or disposed such that it is only possible to insert the orientation projection into the orientation recess in a specific rotational orientation with respect to a central axis of the plug-in section.

### RELATED APPLICATIONS

This is a §371 of International Application No. PCT/EP2010/001335, with an inter-national filing date of Mar. 4, 2010 (WO 2010/099959 A1, published Sep. 10, 2010), which is based on German Patent Application No. 10 2009 013 153.1, filed Mar. 6, 2009, the subject matter of which is incorporated by reference.

### TECHNICAL FIELD

This disclosure concerns a dental model having a base unit having the shape of a section of the jaw and gums of a patient, and having at least one removable tooth component designed to be inserted along the z-axis into a dedicated recess for a tooth component of the base unit, wherein the removable tooth component has a tooth section having the shape of a tooth or a tooth stump.

### BACKGROUND

Related dental models are known. They are used by dental technicians in the production of dental prostheses.

The previous and currently used technology of the related models requires that one or two impressions are made of a portion or all of the patient's dentition, which are then used as negatives for the production of a plaster positive. This plaster positive comprises, therein, in particular, the previously generated tooth stumps, which are to remain in the mouth after having been ground by the dentist, and which subsequently are to serve as anchors for the dental prosthesis that is to be produced. Frequently, the plaster model is sawed into numerous parts after it has hardened to test the dental prosthesis to be produced on the respective tooth stump.

As a further development of this technique, the production of a related dental model by a milling process is also known, wherein the base unit and the at least one removable tooth component are milled separately, and wherein a frequently, substantially cylindrical recess is provided in the base unit to accommodate the at least one dental prosthesis.

As long as the model only has one tooth component, there is no difficulty whatsoever presented by allocation of this tooth component to the tooth component recess provided. There is, however, the problem with a dental model having only one removable tooth component, of inserting this tooth component in the correct orientation into the tooth component recess, because determining the correct orientation of the tooth component is not without difficulty. It frequently is necessary to have a very precise visual inspection and/or to conduct numerous attempts at inserting the tooth component in the tooth component recess to find the correct orientation. It may also be the case that the dental prosthesis has been produced on the basis of an incorrect orientation such that the produced dental prosthesis cannot be used. This is first realized when the completed dental prosthesis is inserted for fitting in the dentition of the patient. Even if the error has been detected first, it is frequently difficult to produce a new dental prosthesis before the appointment with the patient.

The correct insertion of the tooth component in the designated tooth component recess is particularly problematic if the dental model has more than one removable tooth component. Because the shapes of the tooth components are frequently similar, the correct allocation of the tooth components in the tooth component recesses can frequently take a long time. Errors occur here as well, which subsequently result in the production of faulty dental prostheses.

It could therefore be helpful to produce a dental model wherein the disadvantages of the prior art are avoided or at least reduced.

### SUMMARY

We provide a dental model including a base unit having a shape of a section of a jaw and gums of a patient, and at least one removable tooth component which is inserted along a z-axis into a dedicated tooth component recess of the base unit, wherein the removable tooth component includes a tooth section having the shape of a tooth or a tooth stump, the tooth component recess has a substantially cylindrical main recess, the removable tooth component has a plug-in section that is substantially cylindrical and is inserted in the main recess of the tooth component recess, an orientation projection is disposed on one surface of the tooth component away from the tooth section, extending along the z-axis, the tooth component recess that accommodates the orientation projection has an orientation recess adjoining the main recess to accommodate the orientation projection, and the orientation projection and the orientation recesses are designed and/or disposed such that it is only possible to insert the orientation projection into the orientation recess in a specific rotational orientation with respect to a central axis of the plug-in section.

We also provide a method for producing the dental model, wherein the base unit and the at least one tooth component are produced as separate milled components by a milling apparatus, and the base unit is produced from a first blank, the tooth component is produced from a second blank, and the first and second blanks differ with respect to material and/or color.

### BRIEF DESCRIPTION OF THE DRAWINGS

Further aspects and characteristics can be derived from the claims and from the following description of preferred constructions. These are explained below based on the figures. They show:

FIG. 1 is a dental model according to the prior art that serves as a basis for explaining our dental models, wherein FIGS. 1a and 1b show a first example;

FIGS. 2a and 2b show a second example;

FIGS. 3a-3c show a third example;

FIG. 4 shows a fourth example;

FIG. 5 shows a fifth example;

FIG. 6 shows a sixth example;

FIG. 7 shows a seventh example; and

FIGS. 8a and 8b show an eighth example.

### DETAILED DESCRIPTION

According to a first aspect, we provide an improvement on related dental models, in that the tooth component recess has a somewhat cylindrical main recess, wherein the removable tooth component has a plug-in section designed somewhat cylindrically and for insertion in the main recess of the tooth component recess, which has an orientation projection extending along the z-axis disposed on one of the sides of the tooth component facing away from the tooth section such that the tooth component recess for accommodating the orientation projection has an orientation recess in the main recess for accommodating the orientation projection, and wherein the orientation projection and the orientation recesses are designed and/or configured such that it is possible to press the orientation projection into the orientation recess simply by turning in a defined manner in relation to the central axis of the plug-in section.

The central axis of the plug-in section or the projection, respectively, is a geometric axis running parallel to the z-axis and through the center of the plug-in section, or the projection, respectively. The plug-in section and main recess are substantially cylindrical, having a roundness within a tolerance of less than or equal to 1.5 mm. The length of the plug-in section and the main recess along the z-axis is preferably at least 2 mm, particularly preferred is a length of at least 3 mm.

Preferably the dental model has numerous removable tooth components, wherein the tooth sections of the tooth components particularly preferably have, predominantly, or entirely, the shape of a filed tooth stump.

The plug-in section and the main recess are designed to be able to stabilize the tooth component in the tooth component recess. Due to the fact that the plug-in section and the main recess generally have a substantially round cross-section, a simple and reliable orientation of the tooth component is first possible through the additional use of the orientation projection and the orientation recess. For this, in particular, two variations for the design of the orientation projection and the orientation recess are provided.

With the first variation, a central axis of the orientation projection runs eccentrically to the central axis of the plug-in section. Because the tooth component can only be rotated about the central axis in the designated tooth section recess due to the substantially corresponding shape of the plug-in section and the main recess, the eccentric configuration of the orientation projection is only flush with the orientation recess in a specific rotational position, where it can therefore slide into the orientation recess.

It is particularly preferred if the central axis of the orientation projection is at least 1 mm, preferably 1.5 mm, from the central axis of the plug-in section. Eccentricity of this magnitude can be quickly identified by a person holding the model. Insertion of the tooth component in the tooth component recess can thereby be directly inserted in the correct orientation.

It is particularly preferred when there are at least two removable tooth components, each having a plug-in section, and each having an orientation projection, as well as two corresponding tooth component recesses, each having a main recess and an orientation recess respectively, wherein the respective central axes of the orientation projections are displaced in relation to the central axes of the respective plug-in sections towards either an inner or outer surface of the dentition, represented, at least in part, by the dental model.

This uniform orientation of the respective central axes to one another in the correctly inserted state of the tooth components allows the person, solely with a single look at the lower surface of the tooth component, to gauge the correct orientation of the tooth component recess such that the configuration of the orientation recess in the tooth component recess is consistently either outwards or inwards for each of the tooth component recesses.

The second variation of the design of the orientation projection and the orientation recess provides that a cross-section of the orientation projection, and a cross-section of the orientation recess correspond to one another such that the orientation projection can only be inserted into the orientation recess in a specific rotational orientation. With this variation, it is ensured that the insertion is only possible in the correct orientation via their shapes, rather than via the eccentric configuration of the orientation projection and the orientation recess. By way of example, both the orientation projection as well as the orientation recess may each have a cylindrical shape, wherein a cross-section in the shape of an isosceles, but not an equilateral, triangle is obtained, such that the orientation projection can only be inserted in the orientation recess in a predetermined orientation.

According to a second aspect, a dental model of this type is provided wherein the tooth component recesses have a basically cylindrical recess, whereby the removable tooth component has a plug-in section that is basically cylindrical, and designed to be inserted in the main recess of the tooth component recess, and wherein there is a marking disposed on each, on a circumferential surface of the plug-in section of the tooth component, firstly, and secondly on the inner surface of the main recess of the tooth component recess, wherein these markings are configured such that they face each other when the tooth component is correctly inserted in the tooth component recess.

Although these markings cannot mechanically prevent insertion of the tooth component in the wrong orientation, they give the person a simple means, with a short look into the tooth component recess and at the plug-in section of the tooth component, to determine the correct orientation.

In the simplest case, the markings may be colored markings in the form of a line running along the z-axis. It has, however, been considered advantageous if the markings are designed as recesses, preferably as grooves. Recesses of this type can be created already during the production of the tooth component by a milling device.

According to a third aspect, a dental model of this type is provided wherein the tooth component recess extends in the form of a hole through the lower surface of the base unit, whereby the removable tooth component has a through projection which extends through to the lower surface of the base unit when the tooth component is inserted, whereby one of the faces of the through projection of the tooth component facing away from the tooth section, and the lower surface of the base unit fully correspond to one another such that when the tooth component is fully inserted, first, a tooth component reference surface on the end face of the through projection is flush with a directly adjacent base unit reference surface on the lower surface of the base unit and, second, there is a handling surface on the end face of the through projection opposite a part of the lower surface of the base unit directly adjacent to the through projection, or opposite the base unit reference surface on the lower surface of the base unit.

With this design, the tooth component extends accordingly, through the tooth component recess, passing through the base unit by the through projection. The through projection extends at least in part far enough that it extends beyond the lower surface, or at least a partial section of the lower surface of the base unit. The end of the through projection away from the tooth section fulfills, thereby, two functions together with the lower surface of the base unit. First, a reference surface is provided on the through projection, wherein the reference surface extends preferably orthogonally to the z-axis. This reference surface is disposed on the through projection such that it is flush with a directly adjacent reference surface of the base unit when the tooth component is fully inserted such that the reference surfaces of the through projection and the base unit lie in a common plane when the tooth component has reached its end position according to its intended purpose. Second, the end of the through projection away from the tooth section is raised, at least partially, over the lower surface of the base unit such that removal of the tooth component from the tooth component recess by pushing is relatively simple in that force is manually applied to the exposed part of the through projection by a finger.

In this manner, it is possible, using the same through projection, to push the tooth component out of the tooth component recess as well as to inspect the reaching of the end position by the tooth component in the tooth component recess.

Preferably the tooth component reference surface on the end of the through hole and the handling surface on the end of the through hole are flush with one another, while one of the surfaces directly encompassing the through projection on the lower surface of the base unit forms in part the base unit reference surface and in part is recessed along the z-axis in relation to the base unit reference surface.

According to this design, the through projection does not need a shape extending beyond a simple cylindrical design on the end away from the tooth section. Instead, it can preferably end in a uniform end surface constructed as both a reference and handling surface. Accordingly, to be able to inspect the insertion depth by the through projection, as well as obtaining a simple means of handling, the surface which is then directly encompassing the through projection has different sections separated along the z-axis. One of the sections, which can span, by way of example, approx. 180° of the encompassed surface, serves as the reference surface and is accordingly disposed such that the tooth component reference surface and the handling surface are flush with this section when the tooth component is fully inserted. Another section of the encompassing surface is, in contrast, recessed along the z-axis such that the inserted through projection is at least partially exposed by this section, thus allowing manipulation of the tooth component.

A particularly simple possibility for creating these different sections on the encompassing surface consists of the lower surface of the base unit being substantially planar, interrupted, however, by a recessed groove or other type of recess.

According to a fourth aspect, a dental model of this type is provided wherein the base unit and the at least one tooth component consist of different substances and/or have different colors.

Designing the dental model from different materials is advantageous, in particular, because it allows for at least one removable tooth component, taking into account a more difficult and/or slower processing, to be produced from a more wear resistant material, while the base unit can be made from a less wear resistant and, therefore, more easily processed material. This use of different materials is due to the fact that the requirements regarding the wear resistance of a tooth component are greater that with the base unit, because during the production of a dental prosthesis, which is to have a shape corresponding to the tooth section of the tooth component, frequent tests of the dental prosthesis must be carried out during production. The higher degree of wear resistance is advantageous so that the tooth section of the tooth component not gradually change shape as a result of the mechanical load.

This wear resistance, however, is not normally necessary for the base unit. Because the base unit with respect to its outer surface normally makes up the significantly greater portion of the dental model, the use of a softer and less solid material for the base unit leads to a significant reduction in the processing time and to a clearly smaller degree of wear to the tools.

It is therefore considered particularly advantageous if the material of the base unit exhibits a smaller degree of solidity, hardness and/or density than the material of the removable tooth component. For this it is considered advantageous if the hardness, the solidity and/or the density of the material of the base unit is at least 20% less than the solidity, hardness and/or density of the material of the tooth component.

The use of different colored materials for the base unit and the tooth unit also leads to a quicker identification of the removable tooth component and thereby to a more practical handling of the dental model. In particular, when at least one non-removable tooth component is disposed, having the shape of a tooth or tooth stump and that is molded as a part of the base unit as a single unit, it is advantageous if the coloring of the removable tooth component is different, because this makes it directly apparent as to which tooth component is the removable tooth component. A preferred color design provides that the base unit is given a color similar to that of gums, and the tooth components are approximately the color of teeth.

According to a fifth aspect, a dental model of this type is provided having at least two removable tooth components of the type described, which are designed to be inserted along a z-axis in a respective dedicated tooth component recess of the base unit. In this case, a marking is applied to each of the tooth sections, from which it can be derived, which of the tooth component recesses the respective tooth component is assigned to, which of the dentition regions, “incisor region,” “bicuspid region,” and “molar region,” the tooth component belongs to, and/or whether the tooth component is located in the upper or lower jaw, and/or whether the tooth component belongs to the right or left half of the dentition.

According to this aspect, it is accordingly provided that the tooth component have a marking that, without closer examination of the shape of the tooth section, allows conclusions to be drawn as to which position or in which region of the dentition the tooth component is to be located. Particularly with a dental model having numerous removable tooth components, e.g., five or more removable tooth components, it is advantageous if the concrete allocation of the tooth component to a tooth component recess, or at least to the associated region of the dentition, is directly apparent.

It is a particularly simple form of marking if the marking is in the form of text, i.e., a labeling of the tooth component. A labeling can be formed of recesses cut into the tooth component, for example, in particular by means of recesses cut in the plug-in section of the tooth component. It is particularly advantageous if this textual marking conveys the name of the tooth where the tooth component is to be located. This can be accomplished, for example, according to a recognized tooth chart, in particular according to the FDI tooth chart. Alternatively, it is also possible to provide markings that only allow conclusions regarding the corresponding dentition half, or the corresponding quadrant of the dentition, using an “L” for the left half, and an “R” for the right half of the dentition.

An alternative variation of the marking provides that the marking is color coded, preferably in that the tooth components of different jaws, different sides of the jaw, or different dentition regions each have a different color, and in that the tooth components of the same jaws, the same jaw side, or the same dentition region each have identical colors. In this manner it is possible, for example, to assign all tooth components of the molar region a first color, all tooth components of the bicuspid region a second color, and all tooth components of the incisors (including the canines) a third color. It is also possible to incorporate a more extensive differentiation in that the canines are given a fourth color.

With these colorings it would be very easy to allocate the teeth to their respective regions. It is furthermore possible to quite simply distinguish the different regions of the dentition on the dental model at a glance as a result of this, when the removable tooth components are inserted.

In a particularly advantageous aspect, we provide that the marking is made through a molded marking projection on each of the tooth components, wherein the marking projection has a different shape and/or size depending on the criteria of which tooth component recess the tooth component is allocated to, which dentition region, “incisor region,” “bicuspid region,” or “molar region” the tooth component belongs to, and/or whether the tooth component is allocated to the upper jaw or the lower jaw, and/or whether the tooth component belongs to the right or left dentition half.

The marking projection is preferably designed as a cylinder. The varying sizes of the markings of different tooth components relates in a case of this sort in particular to the sizes of the cross-section surfaces of the marking projections. In this manner, it is possible for the marking projection, for example, to have a cross-section surface that becomes increasingly larger for teeth located further out in the dentition. Aside from the size, the shape can also be used, in particular the shape of the cross-section surface such that, for example, tooth components of the molar region may have a marking projection with a pentagonal cross-section surface, the bicuspids may have a marking projection with a quadratic cross-section surface, and the incisor region may have a marking projection with round or elliptical cross-section surfaces.

It is particularly advantageous if the shape of the marking projection represents a marking with respect to a first criterion, and the size of the marking projection represents a marking with respect to a second criterion. In this manner, for example, it may be provided that the tooth components of the molar region, the bicuspid region, or the incisor region have a triangular, quadratic or round cross-section surface, while the size of the cross-section surface depends on how far outwards the tooth component is allocated in its respective region.

It is considered particularly advantageous if the marking projection also forms the orientation projection and/or the through projection. By this means, a double function of the projection is obtained. The shape and/or the size of the projection allows for the allocation of the tooth component to its respective tooth component recess or at least the dentition region that it belongs to. Simultaneously, the projection, in the case where it is designed as an orientation projection, prevents the tooth component from being inserted in the wrong orientation in the tooth component recess. In the case of the through projection design, the marking projection enables not only the marking of the tooth component, but also the simple handling of the tooth component when removing the tooth component from the base unit, as well as a simple inspection upon insertion of the tooth component in the base unit, as to whether the intended insertion depth has been reached.

Aside from the described aspects, intended for a model, we also provide for the production of a model of this type by milling techniques. For this, in particular, the different tooth components, and where applicable, the base unit as well, can also be produced as separately milled components. Production by milling enables thereby the directly integrated incorporation of the orientation projections, the through projections and/or the markings on the tooth components.

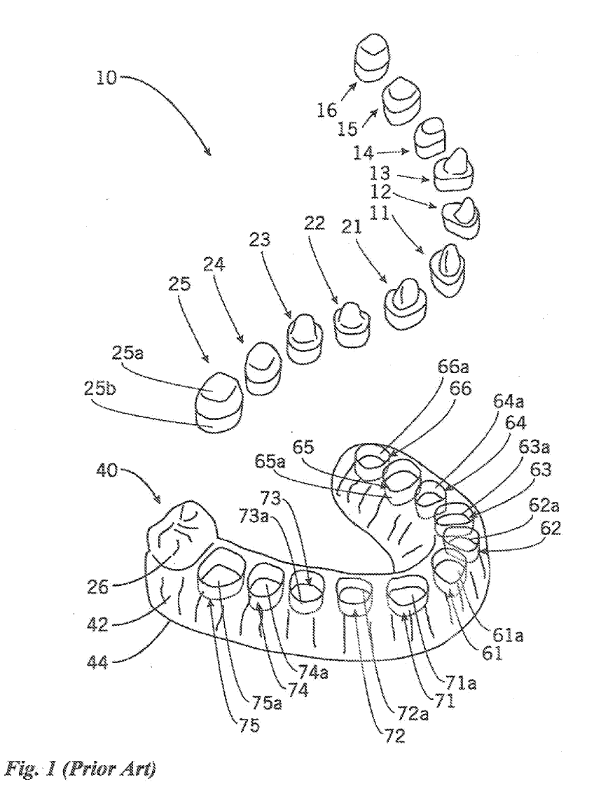

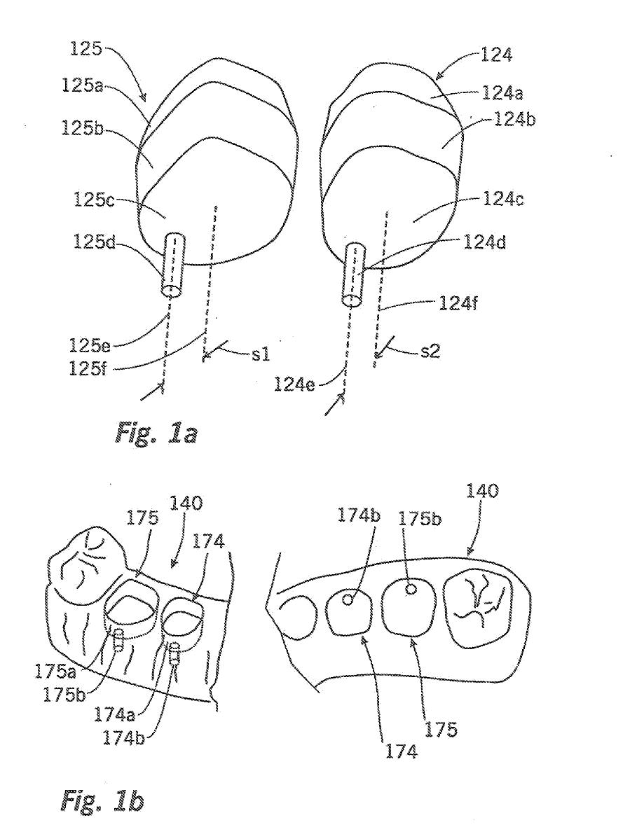

Turning now to the Drawings, FIG. 1 shows a dental model of a partial region of an upper jaw according to the prior art. With a dental model of this type, a base unit 40, and tooth components 11-16, 21-25 are provided. The reference numerals for the tooth components correspond thereby to the naming of said according t the FDI tooth chart.

The base unit 40 is in a somewhat semi-circle shape, corresponding to the upper jaw dentition of a patient. The main section 42 of the base unit 40 provides the shape of the gums of the upper jaw. A molar 26 is molded directly onto the main section 42. Instead of the remaining teeth of the upper jaw of the patient spanned by the base unit 40, tooth component recesses 61-66, 71-75 are provided on the upper surface of the base unit 40. These tooth component recesses 61-66, 71-75 each have a main recess 61a-66a, 71a-75a. This main recess 61a-66a, 71a-75a is substantially cylindrical in shape, whereby to a limited degree conical shapes, or shapes tapering towards a lower surface 44 of the base unit 40 are also possible.

The tooth components 11-16, 21-25 each have a tooth section 25a as well as a somewhat cylindrical plug-in section 25b that abuts the tooth section 25a. The tooth section 25a of the tooth components 11-16, 21-25 has the shape of an already ground tooth stump. This shape can be determined through the production of an impression in the mouth of the patient and a subsequent scanning. The plug-in section 25b of the tooth component 11-16, 21-25 is shaped such that it corresponds to the main recess 61-66, 71-75 of the respective tooth component recess 61-66, 71-75 allocated to the tooth component.

The tooth components 11-16, 21-25 are intended to be inserted in the tooth component recesses 61-66, 71-75. For this, the plug-in section 25b of the tooth components 11-16, 21-25 and the main recesses 61a-66a, 71a-75a correspond to one another such that when the tooth component 11-16, 21-25 is inserted, only its respective tooth section 25a extends above the base unit 40.

The illustrated dental model 10 has an unusually high number of removable tooth components 11-16, 21-25. Normally with a dental model of this type, a larger number of teeth are molded as a part of the base unit, and a smaller number of teeth are replaced with removable tooth stump shaped tooth sections.

In the following, a total of eight examples of our dental models are explained, wherein the reference numbers for components of the same type, with respect to the second and third digits are the same, while the first digits indicate the number of the respective examples.

FIGS. 1a and 1b illustrate a first aspect. FIG. 1a shows the two tooth components 125, 124 in a perspective from diagonally below. FIG. 1b shows a perspective view as well as a top view of the base unit 140 in the region of the tooth component recesses 174 and 175.

To ensure that the tooth components 124, 125 are inserted in the correct orientation in their respective tooth component recesses 174, 175, orientation projections 124d, 125d are disposed on a substantially planar lower surface 124c, 125c of the plug-in section 124b, 125b of the tooth components 124, 125. These orientation projections 124d, 125d extend along the axis, which shall be referred to as the z-axis in the following, indicating the direction of insertion for the tooth components 124, 125. For this, a central axis 124e, 125e, parallel to the z-axis, of the orientation projections 124d, 125d separated from a respective central axis 124f, 125f of the respective plug-in section 124b, 125b at a distance s1, s2 of approx. 1.5 mm. The orientation projection 124d, 125d is thereby eccentrically disposed in relation to the plug-in section 124b, 125b.

Corresponding to these orientation projections 124d, 125d, orientation recesses 174b, 175b are disposed in the tooth component recesses 174, 175, which adjoin the respective main recesses 174a, 175a in the manner visible in FIG. 1b. With respect to the respective main recess 174a, 175a, these orientation projections 174b, 175b are located in an eccentric manner to the same extent as is the case with the orientation projections 124d, 125d in relation to the plug-in sections 124b, 125b.

By this design, the tooth components 124, 125 can only be inserted in a specific orientation in the tooth component recesses 174, 175. In this manner it is also possible to ensure, even with tooth components having a plug-in section that is nearly rotationally symmetrical, that the tooth component is in the correct orientation in the tooth component recess. Due to the clear eccentricity of 1.5 mm, the correct orientation is also readily recognized with the naked eye.

In the examples illustrated herein, the orientation recesses 174b, 175b in relation to the entirety of the dental model are located towards the outer surface such that it is not necessary to check as a result of this uniformity as to where the respective orientation recess is disposed within the tooth component recess. Instead, it is sufficient to quickly determine the location of the orientation projection on the tooth component to be able to insert the tooth component in the correct orientation into the corresponding tooth component recess.

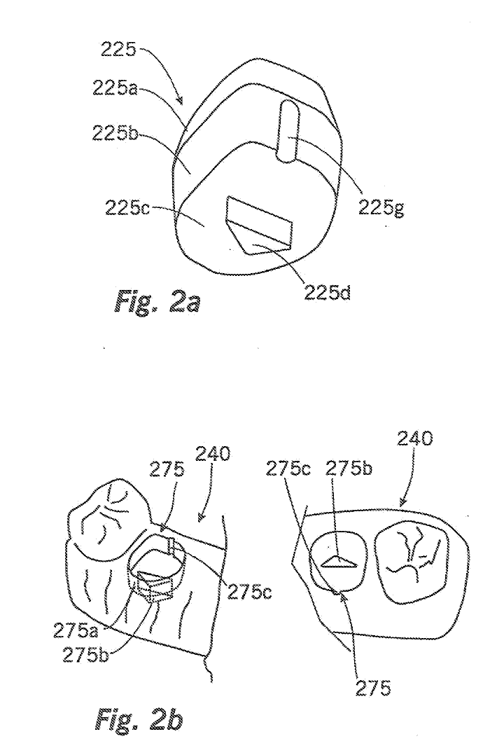

With the examples of FIGS. 2a and 2b, only the tooth component 225 and a section of the base unit 240 with the corresponding tooth component recess 275 are shown.

As can be seen by the illustration in FIG. 2a, the tooth component 225 also has an orientation projection 225d, whereby this differs from the structure of FIGS. 1a and 1b in that it has a non-circular cross-section. The cross-section has the shape of a triangle with rounded corners having three sides of different lengths. As can be seen in FIG. 2b, the orientation recess 275b of the tooth component recess 275 is also shaped in a corresponding triangular manner. As a result of this design, the tooth component 225 can only be inserted in the correct orientation in the tooth component recess 275. Any orientation deviating therefrom prohibits the entry of the orientation projection 225d in the orientation recess 275b.

Furthermore, it may be seen in FIGS. 2a and 2b that there are grooves 225g, 275c extending along the z-axis in the outer surface of the plug-in section 225b as well as in the encompassing surface of the main recess 275a. These grooves 225g, 275c enable the determination of the correct orientation of the tooth component. A correct insertion of the tooth component 275 is then possible when the grooves 225g, 275c face one another.

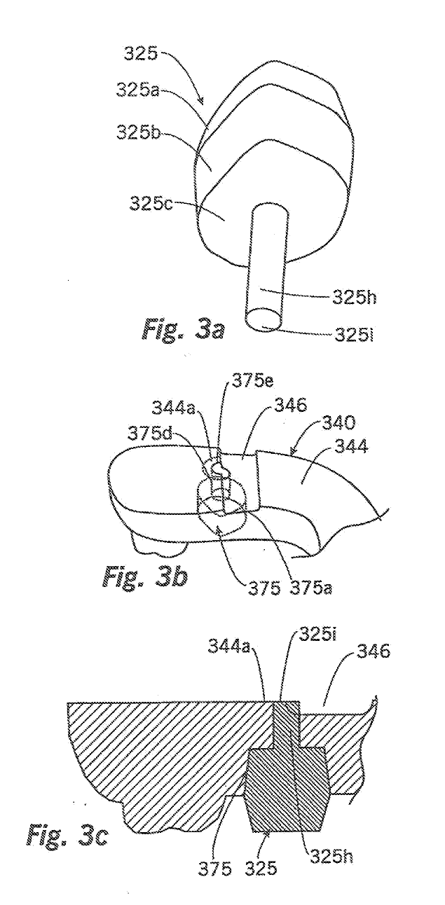

With the examples of FIGS. 3a-3c, a special design of the base unit 340 is provided. To accommodate a through projection 325h, which is connected to the plug-in section 325 b of the tooth component 325, a through hole 375d is provided in the base unit 340. This through hole 375d extends from the main recess 375a of the tooth component recess 375 to the lower surface 344 of the base unit 340. At the region of the opening 375e of the through hole 375d, a recess 346 is provided on the lower surface 344 of the base unit 340, which is disposed such that it overlaps the through hole 375e to some extent, but not entirely.

As can be seen in the cut-away illustration of FIG. 3c, the tooth component 325 and the tooth component recess 375 correspond to one another such that when the tooth component 325 is fully inserted in the tooth component recess 375, an end surface 325i of the through projection 325h is flush with the surface facing away from the recess 346 having a surface section 344a of the bottom surface 344, i.e., lying in a common plane, while the end surface 325i in the region of the recess 346 extends in relation to the lower bottom surface 344.

As a result of this design, it is possible to readily determine whether the tooth component 325 is inserted to a sufficient degree in the tooth component recess 375, because only when the surfaces 325i, 344a are flush, has the end position been reached. On the other hand, the removal of the tooth component 325 is easily possible, as the through projection 325h in the region of the recess 346 can be subjected to force in a simple manner by a finger or fingernail, such that it released from the tooth component recess 375.

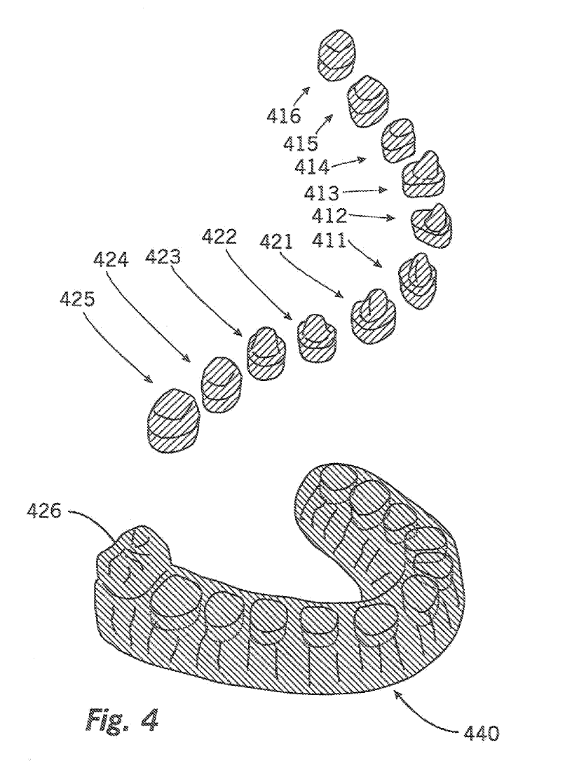

With the example of FIG. 4, the base unit 440 on one hand, and the tooth components 411-416, 421-425 on the other hand, are made of different materials having different coloring. This is indicated by the different shadings. Because the tooth section 426 is disposed as a part of the base unit 440 as a single unit, it has the same coloring as the rest of the base unit 440.

The base unit 440 on one hand, and the tooth components 411-416, 421-425 on the other hand have not only different colorings, but are also made of different materials. As a result, the material of the base unit 440 is a polyurethane substance with a density of 500 kg/m³ and the material of the tooth components 411-416, 421-425 is a polyurethane substance with a density of 1200 kg/m³. The different material selection results in a significant wear resistance for the tooth components 411-416, 421-425 in comparison with the base unit 440. The processing speed with milling processes for the base unit, due to the lesser density and lesser degree of hardness and solidity of the material of the base unit 440, is decidedly simpler and overall quicker. This use of different materials, with respect to the respective wear loads occurring, is useful because the tooth component is subjected to repeated mechanical loads during the fitting of dental prostheses, while the base unit 440 is normally subjected to a lesser degree to mechanical loads.

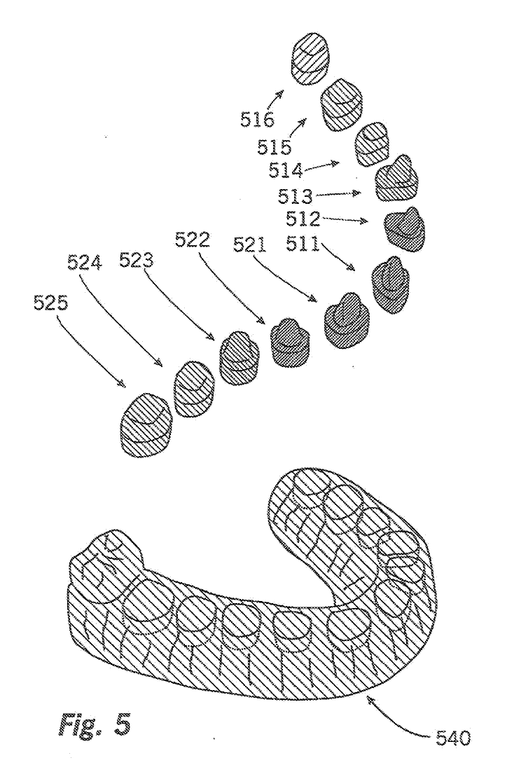

With the design according to FIG. 5, the base unit 540 is again made of a different material than the tooth components 511-516, 521-525. Furthermore, the tooth components 511-516, 521-525 are also made of different materials, or at least have different colorings. The tooth components 511, 512, 521, 522, indicated by the type of shading, are given a first color because they are located in the incisor region. The tooth components 513, 523 in the canine region have a second color. The tooth components 514, 515, 524, 525 have a third color, as they are located in the bicuspid region. The tooth component 516 has a fourth color as the only tooth component from the molar region. The four colors are visibly different from one another. One conceivable color selection would be “red,” “green,” “yellow,” and “blue,” for example.

The use of different colors allows easy determination of which region the respective tooth components belong to. It is thereby possible to allocate the tooth components to their respective tooth component recesses in a substantially quicker manner.

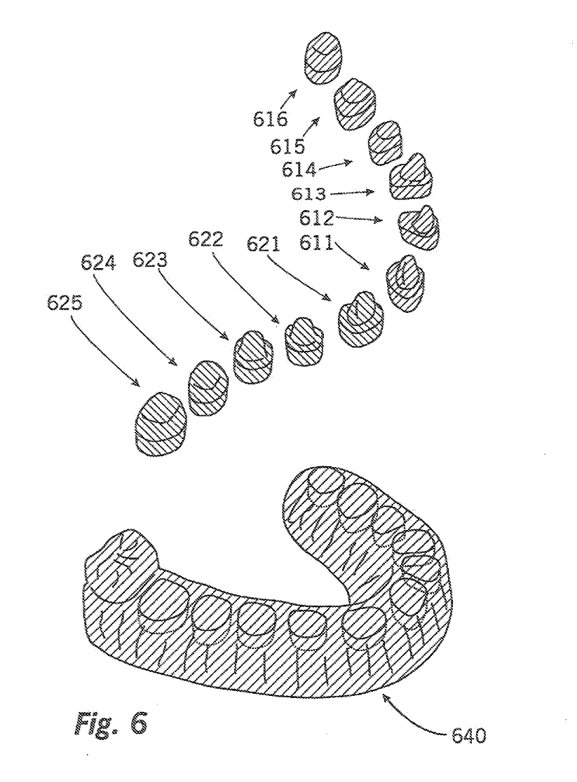

The example of FIG. 6 is similar to the example of FIG. 5. The allocation of the tooth components 611-616, 621-625 however is realized with this example in that the tooth components 621-625 of the left dentition half have a first color, and the tooth components 611-616 of the second dentition half have a different second color.

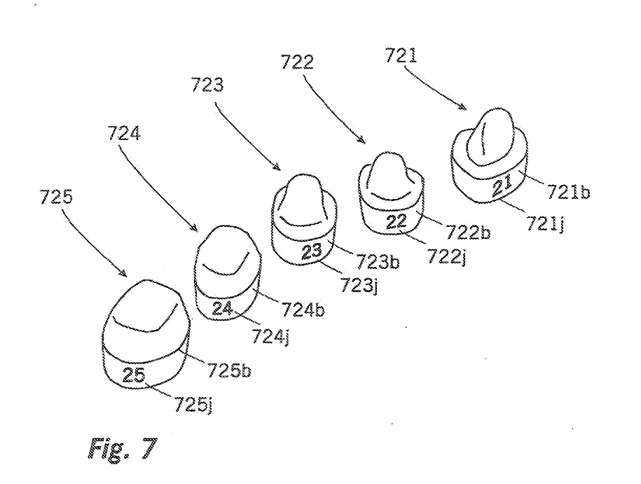

With the example of FIG. 7, the dental prostheses 721-725 are each provided with an engraved textual marking 721j-725j. This textual marking indicates the position of the respective tooth component 721-725 according to the FDI tooth chart. These markings 721j-725j are disposed the outer surface of the plug-in section 721b-725b in each case. They allow immediate identification of the respective intended position of the tooth component 721-725, such that an allocation to the respective dedicated tooth component recesses can be made in a simple manner.

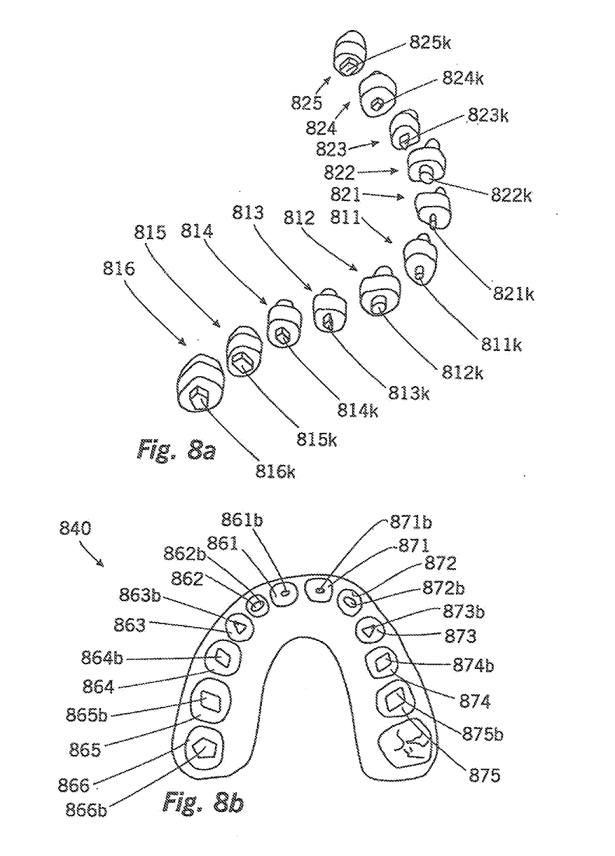

With the example of FIGS. 8a and 8b, marking projections 811k-816k, 821k-825k are disposed on the lower surfaces of the tooth components 811-816, 821-825. This is shown in FIG. 8a. These marking projections 811k-816k, 821k-825k each have a characterizing shape as well as a characterizing size. The shape enables allocation to the molar region, the bicuspid region, the canine region, and the incisor region.

The size of the marking projection enables the identification of the sequential order of the tooth components 811-816, 821-825 within their regions. A larger geometrically similar shape of the cross-section of the marking projection indicates that the tooth component recess 861-866, 871-875 allocated to the respective tooth component is located further outwards on the base unit 840. As a result, it is possible in a simple manner to identify the region of the dentition that the respective tooth component 811-816, 821-825 is allocated to. When comparing numerous tooth components 811-812, 813, 814-815, 816, 821-822, 823, 824-825 of the same region it is furthermore possible to identify the sequence of the tooth components 811-816, 821-825 within their respective regions.

As can be seen in the illustration of FIG. 8, the marking projections 861k-866k, 871k-875k simultaneously function as orientation projections. For this reason, there are orientation recesses 861b-866b, 871b-875b within the tooth component recesses 861-866, 871-875, respectively, having corresponding shapes, respectively.

The design variations illustrated in FIGS. 1a-8b can also be advantageously combined with one another.

All examples presented herein are preferably produced by milling, in particular CNC milling. A database is derived preferably from a scan of a dental impression or a direct intra-oral scan of the dentition. The different materials of the base unit and the tooth components for the examples of FIGS. 4-6 are preferably made available through different blanks.

1. A dental model comprising:
a base unit having a shape of a section of a jaw and gums of a patient, and
at least one removable tooth component which is inserted along a z-axis into a dedicated tooth component recess of the base unit,
wherein
the removable tooth component comprises a tooth section having the shape of a tooth or a tooth stump,
the tooth component recess has a substantially cylindrical main recess,
the removable tooth component has a plug-in section that is substantially cylindrical and is inserted in the main recess of the tooth component recess,
an orientation projection is disposed on one surface of the tooth component away from the tooth section, extending along the z-axis
the tooth component recess that accommodates the orientation projection has an orientation recess adjoining the main recess to accommodate the orientation projection, and
the orientation projection and the orientation recesses are designed and/or disposed such that it is only possible to insert the orientation projection into the orientation recess in a specific rotational orientation with respect to a central axis of the plug-in section.

2. The dental model according to claim 1, wherein a central axis of the orientation projection runs eccentrically to a central axis of the plug-in section.

3. The dental model according to claim 2, wherein the central axis of the orientation projection is separated from the central axis of the plug-in section by at least 1 mm.

4. The dental model according to claim 2, wherein at least two removable tooth components, each having a plug-in section and an orientation projection as well as at least two tooth component recesses, each having a main recess are provided, respective central axes of the orientation projections are, in each case, offset inwardly or outwardly of the dentition that is at least partially represented by the dental model with respect to the central axes of the respective plug-in sections.

5. The dental model according to claim 1, wherein a cross-section of the orientation projection and a cross-section of the orientation recess correspond to one another such that the orientation projection can only be inserted in the orientation recess in one specific rotational orientation.

6. The dental model according to claim 1, herein:
the tooth component recess has a substantially cylindrical main recess,
the removable tooth component has a plug-in section that is substantially cylindrical and is inserted in the main recess of the tooth component recess, and
markings are located on an encompassing surface of the plug-in section of the tooth component and on an inner surface of the main recess of the tooth component recess, respectively, wherein said markings are disposed such that they face each other when the tooth component is inserted in the tooth component recess in a correct orientation.

7. The dental model according to claim 6, wherein the markings are designed as recesses.

8. The dental model according to claim 1, wherein:
the tooth component recess extends to a lower surface of the base unit as a through hole,
the removable tooth component has a through projection that extends to the lower surface of the base unit when the tooth component is fully inserted,
an end surface of the through projection of the tooth component facing away from the tooth section and the lower surface of the base unit correspond to one another such that when the tooth component is fully inserted
a tooth component reference surface on the end surface of the through projection is flush with a directly adjacent base unit reference surface on the lower surface of the base unit, and
there is a handling surface on the end surface of the through projection opposite a portion of the lower surface directly adjacent to the through projection, or opposite the base unit reference surface on the lower surface of the base unit.

9. The dental model according to claim 8, wherein:
the tooth component reference surface on the end surface of the through projection and the handling surface on the end of the through projection are flush with one another, and
one of the surfaces directly encompassing the through projection on the lower surface of the base unit forms in part the base unit reference surface and in part is recessed along the z-axis with respect to the base unit reference surface.

10. The dental model according to claim 1, wherein the base unit and the at least one removable tooth component have different materials and/or have different colors.

11. The dental model according to claim 10, wherein material of the base unit and material of the removable tooth component differ in one or more of the following characteristics:
the solidity of the material of the base unit is less than solidity of the material of the removable tooth component,
hardness of the material of the base unit is less than hardness of the material of the removable tooth component, and
density of the material of the base unit is less than density of the material of the removable tooth component.

12. The dental model according to claim 10, wherein at least one non-removable tooth component is provided, having a shape of a tooth or a tooth stump, and which is molded as a single unit as a part of the base unit.

13. The dental model according to claim 1, wherein at least two removable tooth components are inserted along the z-axis in a respective dedicated tooth component recess of the base unit, wherein a marking is applied to each tooth component, from which it can be derived as to
which of the tooth component recesses the tooth component is allocated to,
which of dentition regions, “incisor region,” “bicuspid region,” or “molar region” the tooth component belongs to, and/or
whether the tooth component is allocated to an upper or lower jaw and/or whether the tooth component belongs to right or left half of the dentition.

14. The dental model according to claim 13, wherein the marking is textual and uses a recognized tooth chart selected from the group consisting of a tooth chart, a Zsigmondy tooth chart, a Haderup system, or an American system.

15. The dental model according to claim 13, wherein the marking is color-coded, such that
the tooth components of different jaws, different sides of the jaw, or different dentition regions have different colorings respectively, and
the tooth components of the same jaws, the same sides of the jaw, or the same dentition regions have identical colors respectively.

16. The dental model according to claim 13, wherein the marking is a marking projection on the tooth section, wherein the marking projection has a different shape or size depending on:
which of the tooth component recesses the tooth component is allocated to,
which of dentition regions, “incisor region,” “bicuspid region,” or “molar region” the tooth component belongs to, and/or
whether the tooth component is allocated to an upper or lower jaw and/or whether the tooth component belongs to right or left half of the dentition.

17. The dental model according to claim 16, wherein a shape of the marking projection represents a marking with respect to a first criterion, and size of the marking projection represents a marking with respect to a second criterion.

18. The dental model according to claim 16, wherein the marking projection forms the orientation projection and/or the through projection as well.

19. A method for producing a dental model according to claim 1, wherein the base unit and the at least one tooth component are produced as separate milled components by a milling apparatus, and
the base unit is produced from a first blank,
the tooth component is produced from a second blank, and
the first and second blanks differ with respect to material and/or color.

20. The method according to claim 19, wherein the second blank consists of a material, hardness, solidity and/or density of which is greater than that of material of the first blank, wherein the hardness, solidity and/or density of the second blank is at least 20% greater than that of the first blank.
